(19) United States
(12) Patent Application Publication
(10) Pub. No.: US 2006/0175763 A1
(43) Pub. Date: Aug. 10, 2006

(54) Cylinder head gasket

(76) Inventors: Uwe Duckek, Langenau (DE); Gunther Unseld, Neenstetten (DE); Johann Waldvogel, Krumbach (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/546,745

(22) PCT Filed: Feb. 27, 2004
(86) PCT No.: PCT/EP04/01963

§ 371 Date: Nov. 14, 2005

(30) Foreign Application Priority Data
Feb. 28, 2003 (DE) 103-10-014.8

(51) Int. Cl. F02F 11/00

(52) U.S. Cl. 277/593

(57) ABSTRACT

The inventive flat cylinder head seal ring consists of at least one metallic layer (1, 2) and at least one cylinder through hole and another through hole embodied therein. A first deformation limiting element (6) is formed at least partially around at least one cylinder through hole and a bead (5) which extends along the entire length of the periphery of the cylinder through hole for forming a seal on the side of the first deformation limiting element (6) opposite to the said cylinder through hole. In addition, a second deformation limiting element (7) provided with a wave or trapeze-shaped profile is arranged on the side of the bead (5) opposite to the first deformation limiting element (6) in the area of the edge periphery and/or at least in the area of the other through hole.

The invention relates to a cylinder head flat gasket according to the preamble of claim 1.

A flat gasket of at least one metal layer is known from WO 01/96768 A1, which in particular is designed as a cylinder head gasket. The gasket contains at least one cylinder through-opening. In order to achieve a high sealing effect, also over a longer operational lifetime, the cylinder through-opening is completely surrounded by a bead which is formed in the layer or at least one of several metallic layers. In order to prevent the bead from being plastically deformed to such an extent that it loses its complete elasticity, a deformation limiter is provided which with the known flat gasket has the shape of a wave-like, trapezoidal and/or saw-tooth shaped profiling around the through-opening. With this, the profiling is arranged at least on one side adjacent to the bead, wherein the bead may also be integrated into the profiling.

So that the desired sealing effect is achieved, the cylinder head is screwed onto the cylinder block amid high compression forces. Observed from the respective cylinder through-opening, the corresponding screw through-openings or through-holes are located on the oppositely lying side of the bead or profiling. Because of this, there exists the danger that the cylinder head is excessively distorted with large tightening forces, and in the worse case fractures form. This is encouraged further due to the profiling on one side.

In order to solve this problem, a three-layer cylinder head gasket of metal is known from EP 0 581 615 A1, whose middle layer comprises for each cylinder through-opening a bead surrounding the cylinder through-openings, as well as for both longitudinal ends a bead running adjacent and parallel to the longitudinal ends. Here however there exists the danger of a loss in the elasticity of this gasket.

A single-layer cylinder head gasket of metal is further known from EP 0 927 844 A2 which is likewise provided for each cylinder through-opening with a bead surrounding the cylinder through-opening, and which carries wedges applied in the corner regions which are to prevent a distortion of the cylinder head. This however may only be reduced, but not ruled out since the bead is flexible and the wedges are rigid. The wedges furthermore represent separately manufactured elements so that the manufacturing costs of this cylinder head gasket are relatively high.

Proceeding from WO 01/96768 A1, it is the object of the present invention to improve a cylinder head flat gasket in a manner such that it effectively and economically prevents an excessive deformation of the cylinder head on account of the screw forces. According to the invention, a cylinder head flat gasket with the features of claim 1 achieves this object. Advantageous further formations of the flat gasket according to the invention are to be deduced from the dependent claims.

According to the invention thus a second deformation limiter is suggested, which is either arranged in the region of the peripheral edge and/or in the region of the at least one further through-opening. With this, it has been shown to be favourable if the second deformation limiter is designed in the shape of a wave-like profiling. If moreover the first, inner deformation limiter is likewise provided as a wave-like or trapezoidal profiling at least in one of the metallic layers, the outer profiling may be formed in the same working step as the inner profiling, for example by way of embossing, so that only slight additional costs arise for its manufacture. Basically the first deformation limiter may however have any shape, i.e. for example by way of bending up a layer or by way of a separate ring.

Preferably the outer profiling runs at a slight distance to the peripheral edge of the flat gasket. With this there exists the possibility of the profiling being formed in sections along the transverse or longitudinal edges. It is however likewise also conceivable for the profiling in sections to be present either only on at least one transverse edge or at least one longitudinal edge.

In another embodiment, the outer profiling at least partly is led around the respective further through-openings.

It is also possible to arrange the profiling in a tangential orientation to at least one further through-opening. With this, the second deformation limiter is distanced to the through-opening.

With the cylinder head gasket according to the invention, the at least one further opening is a screw hole or a blind hole.

The outer profiling extends preferably over at least one period of the wave shape, wherein the compressive strength increases with the number of periods and by way of this the resistance to excessive deformations may be set in a desired manner. The term wave shape within the context of this patent application also includes truncated, trapezoidal wave profiles.

If the second deformation limiter were not present, then an increase in height of the first deformation limiter (wave profile) would also mean an increase of the tension produced in the cylinder head and in the cylinder block, so that it would not be possible to freely select the operating region of the bead.

Due to the use of the second deformation limiter whose height is smaller that that of the first deformation limiter, it is however possible to set the tension and the degree of compression to the respective desired value independently of one another, since the tension is only dependent on the height difference of the deformation limiters, and the degree of compression only on the absolute height of the first deformation limiter.

According to a further preferred embodiment, it is therefore suggested that the second deformation limiter has a smaller height than the first deformation limiter. By way of this, the cylinder head and the cylinder block may be held with slight tension which may be infinitely set by way of a suitable choice of the height difference of the deformation limiters, so that on the one hand the tension is limited such that no excessive distortions or even a fracture formation occurs, but on the other hand is so large that the sealing gap movement remains limited and the degree of pressing varies within the optimal range.

The invention is hereinafter described in more detail by way of embodiment examples represented in the figures. There are shown in:

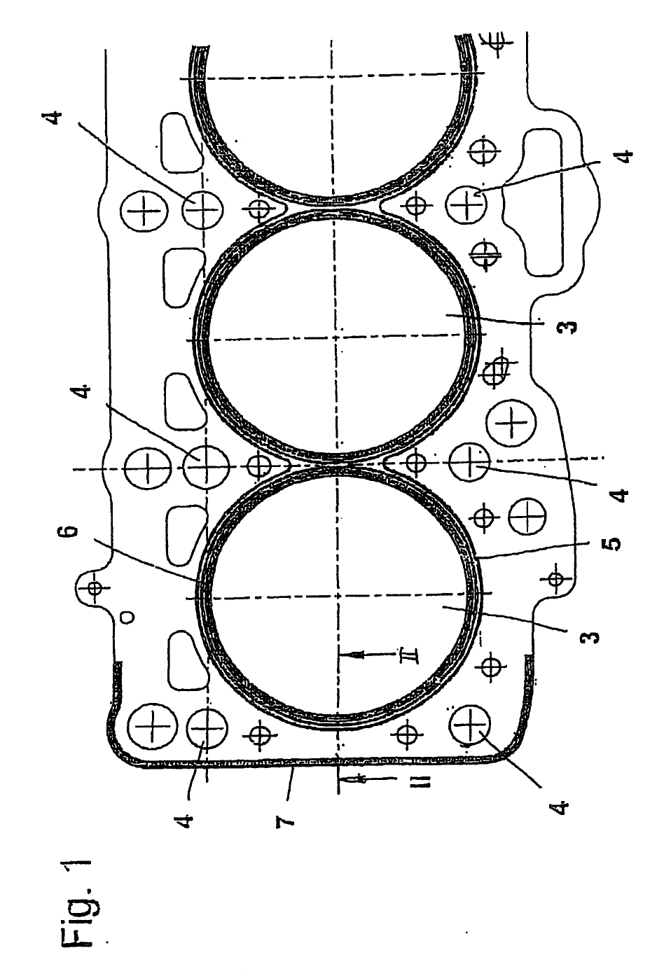

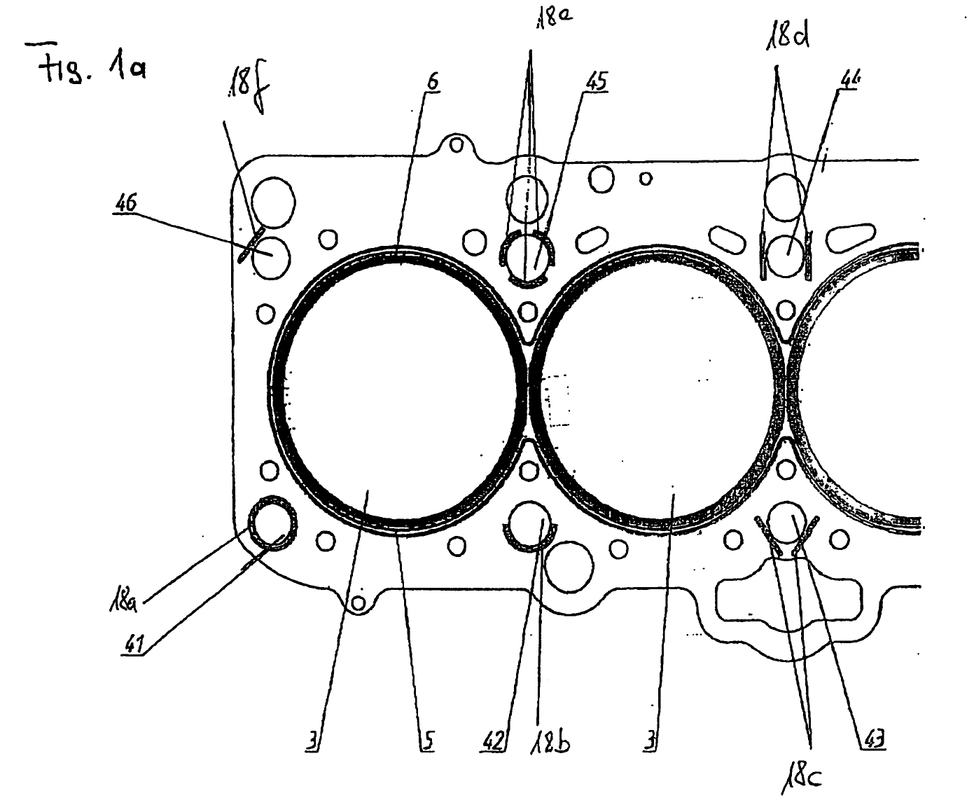

FIG. 1 a plan view of a part of a cylinder head gasket for a four-cylinder motor,

FIG. 1a a further plan view of a part of a cylinder head gasket for a four cylinder motor,

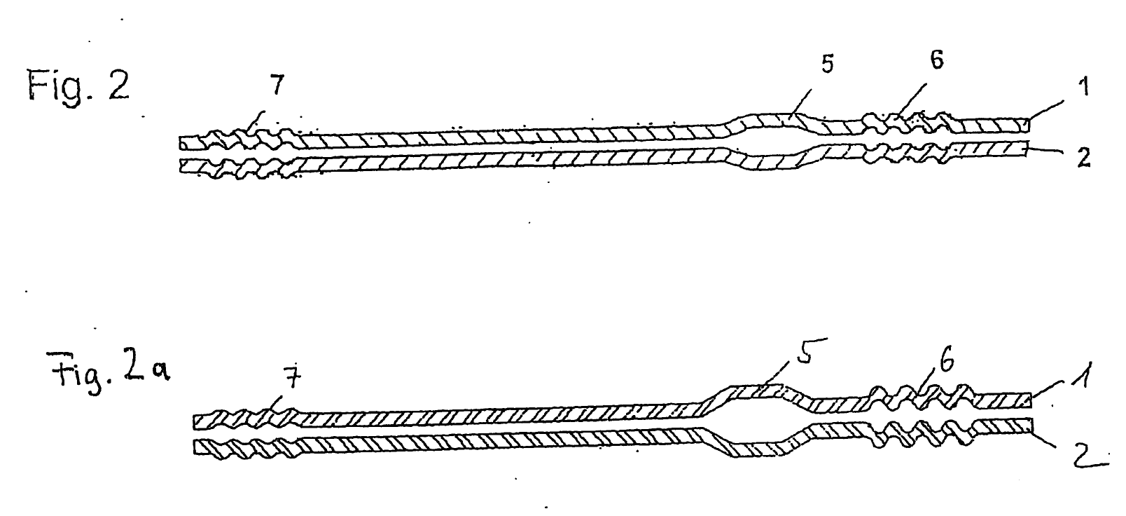

FIG. 2 a perpendicular cross section through an edge region of the cylinder head gasket along line II-II in FIG. 1 in an enlarged representation,

FIG. 2a a perpendicular cross section through an edge region of one variant of the cylinder head gasket along line II-II in FIG. 1 in an enlarged representation, and

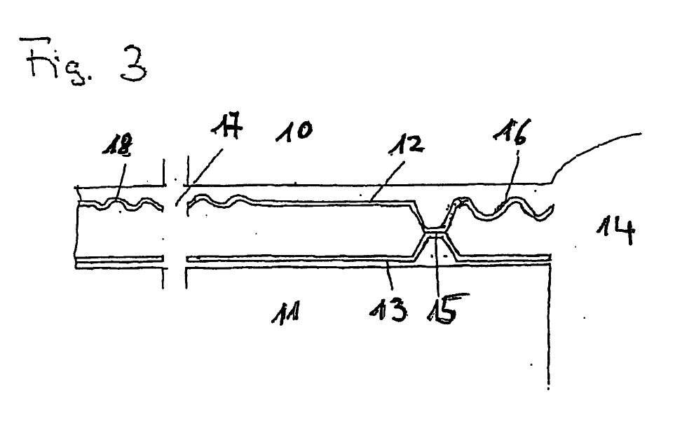

FIG. 3 a perpendicular cross section through a part of a flat gasket, with which the second deformation limiter is formed by a wave profile in one layer of the gasket in the vicinity of the screw through-opening.

The cylinder head gasket represented in the FIGS. 1 and 2 consists of two metallic layers 1, 2 which lie above one another and which are provided with various through-openings 4 which are aligned to one another, in particular cylinder through-openings 3, screw through-openings as well as openings for cooling water, oil, tappets and centering means which have not been indicated.

For each cylinder through-opening 3, the gasket comprises a bead 5 surrounding this, which according to FIG. 2 is designed in both layers 1, 2 in a manner such that these contain oppositely directed convexities.

Furthermore, as is known from WO 01/96768 A1, an inner profiling runs parallel to each bead 5 in the direct vicinity of this on the side which in each case faces the cylinder through-opening 3, and this profiling is formed by a wave-like or trapezoidal embossing in the layers 1, 2. This profiling may also be provided in only one of the layers 1, 2. This profiling also need not be completely peripheral as the bead 5, but may also consist of ring segments. In its transverse direction it is preferably formed in each case of several wave peaks and wave troughs which alternate with one another, and due to its shape has a significantly greater stiffness than the bead 5, so that it may act as a deformation limiter 6 for this.

At the represented longitudinal end (and likewise at the longitudinal end which has not been shown) the cylinder head gasket comprises an outer profiling in a manner such that seen from the adjacent cylinder through-opening 3, it runs behind the two end-side screw through-openings 4. In the shown embodiment example, the profiling 7 runs in the close proximity and parallel to the outer edge of the cylinder head gasket, wherein it extends beyond the end-side of the gasket and to both sides of this beyond in each case a small part of the longitudinal side. The course of the profiling may furthermore be selected such that at least one further through-opening, e.g. a screw through-opening, is partly or completely surrounded by it.

The profiling here, as the profiling on the cylinder through-openings 3, consists of wave-like embossing in both layers, wherein these here are likewise formed of several periods. The embossing are such that the wave peaks of both layers lie on one another, but they may also be formed such that the wave peaks of the one layer mesh into the wave troughs of the other layer. This profiling is indicated as a second deformation limiter 7.

With this profiling too, the embossing may be located in only one of the two layers 1, 2. The profiling in the interior may also be fashioned completely differently than the profiling around the cylinder through-openings 3. Generally it is the case that the present cylinder head gasket may have any number of layers, for example one to six layers, and that the outer profiling may be provided in any of these layers and with any shaping. Examples for a possible arrangement and design of the outer profiling with cylinder head gaskets with a different number of layers are shown in WO 01/96768 A1, but here it is however the case of the inner profiling.

It is also possible to influence the elasticity of the profiling by way of a partial or complete filling of the wave troughs e.g. with elastomeric material. A further possibility lies in changing the amplitude which preferably lies in the range of 0.02 to 0.2 mm, and/or the distances of the wave peaks within the profiling. Furthermore, the wave peaks may be truncated up to a trapezoidal shape and the thickness of the respective layer may vary in the region of the profiling. It is likewise possible to vary these parameters of the profiling parallel to the wave peaks and troughs.

FIG. 1a shows a further embodiment of a gasket according to the invention, with which the outer profiling (deformation limiter 7) does not run in the vicinity of the outer edge as the deformation limiter 7, but in the vicinity of the further through-openings as a deformation limiter 18. Various embodiments 18a-f for outer profiling on through-openings are represented by way of example by way of the screw through-openings 41 to 46. It is likewise also possible here to combine different embodiments for the outer profiling, and it is of course also possible to vary profile parameters such as e.g. wave heights and widths between the various through-openings.

A profiling 18a which runs peripherally in an approximately concentric and complete manner around the screw through-opening 41 is represented at the screw through-opening 41. The wave profile here may vary from period to period with respect to the height and width of the peaks and troughs. It is likewise possible to circumferentially vary the parameters.

A likewise concentric but only partially circumference profiling 18b is represented at the screw through-opening 42. Here too variations in the various wave parameters are possible.

The profiling 18c at the screw through-opening 43 likewise runs in sections, but not concentrically, but distanced and tangentially to the screw through-opening. The profiling 1 8d on the screw through-opening 44 differs only slightly from this, and does not run completely on the side distant to the screw through-opening, but parallel to the web between the combustion chambers 3. With regard to variations of the wave parameters, it is the same case as with the profiling shown at the other screw through-openings.

The screw through-opening 45 comprises a concentric wave profiling 18e which is not completely circumferential. What is different to the screw through-opening 42 is that the wave profiling comprises several circular segments. It has been shown that it is advantageous if the sum of the circle segments amounts to at least ⅙ of the circumference of the circle.

As a further example for a profiling on a screw through-opening, the screw through-opening 46 has a profiling 18f which as with the openings 43 and 44 runs distanced and tangentially to the opening. Here the profiling however comprises only a single segment. As with the concentric wave profiling, it is the case that the sum of the average lengths of the linearly running profilings must be at least 60°.

Of course the profilings 18e and 18f shown at the screw through-openings 45 and 46 may have variations in the wave parameters.

FIG. 2a shows one variant to FIG. 2 with which however the profiling (deformation limiter 6) is higher on the side of the bead which faces the combustion chamber than the height of the profiling (deformation limiter 7) on the other side of the bead.

The flat gasket shown in FIG. 3 is arranged between a cylinder head 10 and a cylinder block 11 and comprises two layers 12, 13 of metal, preferably of spring steel which reach up to a combustion chamber 14 formed in the cylinder block 11, and whilst forming a cylinder through-opening are led around this.

The gasket for the cylinder through-opening comprises a bead 15 which completely surrounds this and which in both layers 12, 13 is formed in a manner such that these comprise convexities which are directed to one another. The bead 15 serves for sealing the combustion chamber and for this is subjected to a compression force which must have a certain minimum value.

A wave profile runs parallel to each bead 15 and in the direct vicinity of this bead on the respective side which faces the combustion chamber, and is formed by a wave-like embossing in the layer 12. The wave profile, as also the bead 15, may also be provided in both layers 12, 13. It however does not need to be completely circumferential as the bead 15, but may consists of ring segments. In its transverse direction it is formed in each case of preferably several wave peaks and wave troughs alternating with one another, and on account of its shape has a considerably larger stiffness than the bead, so that it may act as a deformation limiter 16 for this.

A screw through-opening 17 is located in the gasket on the side of the bead 15 which is distant to the wave profile and at a relatively large distance to this, through which a screw which is not shown is guided in order to fasten the cylinder head 10 on the cylinder block 11 and simultaneously to exert the necessary sealing force onto the bead 15. The gasket in this region in the layer which in the vicinity of the combustion space comprises a wave-like profiling likewise comprises a wave-like profiling (deformation limiter 18). As is clear from the shown embodiment, it is preferable for the profiling (deformation limiter 16) in the vicinity of the combustion space to have a larger amplitude than that at the side of the combustion chamber bead 15 which is distant to the combustion space. As with a second profiling in the vicinity of the outer edge 7, this profiling too may run around the screw through-opening only in regions. The sum of the angular segments should at the same time correspond to at least ⅙ of the circumference of the circle. Furthermore it is of course also possible for the amplitude, distance of wave peaks and/or troughs or their lengths to vary in a circumferential and/or radial manner. As already shown by way of the profiling 18c, d, f at the screw through-openings 43, 44 and 46, at the same time it is not necessary for the profiling to run concentrically.

1-13. (canceled)

14. A gasket comprising
at least one metallic layer having at least one cylinder through-opening and a peripheral edge;
a bead disposed circumferentially around said at least one cylinder through-opening between said at least one cylinder through-opening and said peripheral edge;
a first deformation limiter formed between said at least one cylinder through-opening and said bead;
a second deformation limiter disposed between said peripheral edge and said bead; and
wherein at least a portion of said second deformation limiter is a wave-like structure or a trapezoidal structure in a profile of said at least one metallic layer.

15. The gasket of claim 14, wherein is said second deformation limiter is proximate said peripheral edge.

16. The gasket of claim 14, wherein said second deformation limiter is disposed at both a first longitudinal end and a second longitudinal end of said gasket.

17. The gasket of claim 14, wherein an outer profiling is at least partially disposed around a no-cylinder through-opening.

18. The gasket of claim 17, wherein said non-cylinder through-opening is a fastener through-opening.

19. The gasket of claim 14, wherein said wave-like structure includes truncated wave peaks up to said trapezoidal structure.

20. The gasket of claim 14, wherein said wave-like structure includes different peak heights.

21. The gasket of claim 14, wherein said wave-like structure includes different distances between peaks.

22. The gasket of claim 14, wherein said second deformation limiter is smaller in height than said first deformation limiter.

23. A cylinder head flat gasket having at least two metallic layers and at least one cylinder through-opening and a peripheral edge comprising:
at least a first metallic layer;
a first bead disposed circumferentially around a first cylinder through-opening of said first metallic layer disposed between said first cylinder through-opening and the peripheral edge;
a first deformation limiter formed between said first cylinder through-opening and said first bead;
a second deformation limiter disposed between the peripheral edge and said first bead;
at least a second metallic layer generally aligned with said first metallic layer;
a second bead disposed circumferentially around said first cylinder-through opening of said second metallic layer disposed between said first cylinder through-opening and the peripheral edge, said beads being generally aligned; and
wherein at least a portion of said second deformation limiter is a wave-like structure or a trapezoidal structure in a profile of said at least one metallic layer.

24. The cylinder head flat gasket of claim 23, wherein said first bead includes a first peak extending upwardly and said second bead includes a second peak extending downwardly, said peaks extending away from each other.

25. The cylinder head flat gasket of claim 24, wherein said peaks of said beads are flat.

26. The cylinder head flat gasket of claim 24, wherein said peaks of said beads are generally round.

27. The cylinder head flat gasket of claim 23, wherein said first bead includes a first peak extending downwardly and said second bead includes a second peak extending upwardly, said peaks being in selective contact with each other.

28. The cylinder head flat gasket of claim 23, wherein said second deformation limiter is disposed at both a first longitudinal end and a second longitudinal end of said gasket.

29. The cylinder head flat gasket of claim 23, wherein an outer profiling is at least partially disposed around a third through-opening.

30. The cylinder head flat gasket of claim 23, wherein said third through-opening is a screw through-opening.

31. The cylinder head flat gasket of claim 23, wherein said first deformation limiter includes a second wave-like or trapezoidal structure.

32. The cylinder head flat gasket of claim 31, wherein said second deformation limiter includes a smaller said wave-like or trapezoidal structure than said first deformation limiter.
